(19) United States
(12) Patent Application Publication
(10) Pub. No.: US 2018/0115920 A1
(43) Pub. Date: Apr. 26, 2018

(54) ETHERNET FRAMES ENCAPSULATION WITHIN CPRI BASIC FRAMES

(71) Applicants: NEC Europe Ltd., Heidelberg (DE); Universidad Carlos III De Madrid, Leganes, Madrid (ES)

(72) Inventors: Antonio de la Oliva Delgado, Madrid (ES); Xavier Costa Perez, Heidelberg (DE); Jose Alberto Hernandez Gutierrez, Fuenlabrada, Madrid (ES)

(21) Appl. No.: 15/564,739

(22) PCT Filed: Nov. 23, 2015
(86) PCT No.: PCT/EP2015/077395

§ 371 Date: Oct. 6, 2017

(51) Int. Cl. H04W 28/02

(52) U.S. Cl. CPC H04W 28/0205; H04L 12/4633; H04L 2212/00

(57) ABSTRACT

A radio base station system includes at least one Radio Equipment Control (REC) that comprises radio functions of a digital baseband domain, and at least one Radio Equipment (RE) that serves as an air interface and comprises analogue radio frequency functions. A Common Public Radio Interface (CPRI) link connects the at least one REC and the at least one RE. CPRI traffic carried by the CPRI link leaves an amount of spare capacity. The CPRI link carries non-CPRI traffic encapsulated within the spare capacity.

### CROSS-REFERENCE TO PRIOR APPLICATION

This application is a U.S. National Stage Application under 35 U.S.C. § 371 of International Application No. PCT/EP2015/077395 filed on Nov. 23, 2015. The International Application was published in English on Jun. 1, 2017 as WO 2017/088902 A1 under PCT Article 21(2).

### STATEMENT REGARDING FUNDING

The work leading to this invention has received funding from the European Union's Horizon 2020 Programme under grant agreement no 671598.

### FIELD

The present invention generally relates to a radio base station system and to a method for Common Public Radio Interface (CPRI) basic frame assembly.

### BACKGROUND

According to the latest predictions (for reference, see “Cisco visual networking index: Forecast and methodology, 2014-2019,” Cisco White Paper, May 2015, online available under: <<http://www.cisco.com/c/en/us/solutions/collateral/service-provider/ip-ngn-ip-next-generation-network/white_paper_c11-481360.pdf>>) mobile data traffic will globally increase 10-fold between 2014 and 2019. Mobile data traffic will grow at a compound annual growth rate (CAGR) of 57 percent between 2014 and 2019, reaching 24.2 exabytes per month by 2019. Radio access network (RAN) technologies serving this mobile data tsunami will require fronthaul and backhaul solutions between the RAN and the packet core capable of dealing with this increased traffic load.

Centralized/Cloud RAN (C-RAN) is the most promising technology to address this challenge with CPRI-based (Common Public Radio Interface) C-RAN being the most deployed solution nowadays. Given that CPRI will be a fundamental part of future mobile networks, an efficient way of exploiting unused resources of CPRI-based C-RAN solutions will be required.

CPRI is a specification (for reference, see CPRI Specification V6.1 (2014 Jul. 2001) “Common Public Radio Interface (CPRI); Interface Specification”) for the transmission of digital radio samples (DRoF, Digitized Radio over Fiber) between Radio Equipment (RE, which generally refers to the radio part of a base station) and Radio Equipment Controllers (REC, which generally refers to the base band processing of the base station), often using fiber optics. CPRI is designed to carry the radio samples between one or many REs towards an REC over long distances.

CPRI defines a synchronous Constant Bit Rate transmission stream between the RE and REC. In CPRI, the basic transmission unit is the so-called Basic Frame, transmitted every 260.4167 ns. This Basic Frame comprises one word of control and 15 words of data. The size of each word depends on the bandwidth capacity. Essentially, CPRI as currently specified uses the whole link capacity, either transmitting raw radio data (in the form of I/Q samples) or IDLE, leaving no empty space between CPRI frames. As a result, depending on the applied configuration, according to the current specification of CPRI there is a certain amount of available capacity that remains unused. The following table provides an illustration of the unused capacity depending on the different CPRI options currently specified and the associated data rates:

| | | % spare capacity in | | |
|---|---|---|---|---|
| CPRI | Data Rate | 1G | 10G | 40G |
| Option | (Mb/s) | transceiver | transceiver | transceiver |
| 1 | 614.4 | 39% | 94% | 98% |
| 2 | 1228.8 | — | 88% | 97% |
| 3 | 2457.6 | — | 75% | 94% |
| 4 | 3072 | — | 69% | 92% |
| 5 | 4915.2 | — | 50% | 88% |
| 6 | 6144 | — | 39% | 84% |
| 7 | 9830.4 | — | 2% | 75% |
| 7A | 8110.08 | — | 19% | 80% |
| 8 | 10137.6 | — | — | 75% |
| 9 | 12165.12 | — | — | 70% |

### SUMMARY

In an embodiment, the present invention provides a radio base station system. The radio base station includes at least one Radio Equipment Control (REC) that comprises radio functions of a digital baseband domain, and at least one Radio Equipment (RE) that serves as an air interface and comprises analogue radio frequency functions. A Common Public Radio Interface (CPRI) link connects the at least one REC and the at least one RE. CPRI traffic carried by the CPRI link leaves an amount of spare capacity. The CPRI link carries non-CPRI traffic encapsulated within the spare capacity.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view illustrating the general concept of a radio base station system in accordance with an embodiment of the present invention,

FIG. 2 is a schematic view illustrating CPRI and non-CPRI frames in a radio base station system according to FIG. 1 that are to be aggregated on a common CPRI link in accordance with an embodiment of the present invention,

FIG. 3 is a schematic view illustrating CPRI Basic Frames in a radio base station system according to FIG. 1 that contain the CPRI and non-CPRI frames of FIG. 2 in accordance with an embodiment of the present invention,

FIG. 4 is a schematic view illustrating the placement of signaling and control elements in accordance with an embodiment of the present invention,

FIG. 5 is a schematic view illustrating the process of multiplexing and fragmentation of Ethernet frames in accordance with an embodiment of the present invention, and

FIG. 6 is a schematic view illustrating the structure of an aggregation point of a radio base station system in accordance with an embodiment of the present invention.

### DETAILED DESCRIPTION

An aspect of the present invention provides a radio base station system and a method for CPRI basic frame assembly in such a way that the efficiency of the CPRI bandwidth utilization is enhanced and the amount of available capacity that remains unused will be reduced.

In accordance with an embodiment of the invention, the aforementioned improvements and developments are provided by a radio base station system, comprising:

at least one Radio Equipment Control, REC, that comprises radio functions of a digital baseband domain,

at least one Radio Equipment, RE, that serves as an air interface and comprises analogue radio frequency functions, and

a CPRI link connecting said at least one REC and said at least one RE, wherein the CPRI traffic carried by said CPRI link leaves an amount of spare capacity, and

said CPRI link carries non-CPRI traffic encapsulated within said spare capacity.

Furthermore, the above objective is accomplished by a method for CPRI basic frame assembly, the method comprising:

providing an aggregated CPRI link that carries CPRI traffic from one or more CPRI links,

determining an amount of spare capacity of said aggregated CPRI link, and

encapsulating non-CPRI frames within said spare capacity.

According to an embodiment of the invention, it has been recognized that a CPRI-based C-RAN architecture, which currently requires the deployment of large fiber installations dedicated solely to the transmission of CPRI traffic, might be ineffective under certain conditions. Since at present CPRI, due to its transmission continuity, does not allow the multiplexing of CPRI streams with any other kind of traffic sources in the same link as CPRI, namely packet-based traffic over the same transmission media, this might result in available capacity being unused. In order to effectively use this spare capacity, embodiments of the present invention provide mechanisms (that do not break the current CPRI standard) to encapsulate other-than-CPRI data sources, e.g. variable-size Ethernet frames, within the spare capacity of CPRI basic frames.

Current state of the art does not support the aggregation of non-CPRI (e.g. Ethernet) frames in CPRI links. Current CPRI technology forces the use of high speed, high cost links to connect the REs and RECs. Embodiments of the present invention enable operators to use the spare capacity of these links to carry other kind of traffic hence increasing the options to deploy CPRI links while reducing the overall cost of operation. Furthermore, embodiments of the present invention will help alleviate the congestion in the links connecting the core with the RAN by the better use of already deployed fiber links. Although embodiments of the invention require a certain minimum speed of the CPRI link aggregating the traffic, this is not considered very critical since, typically operators deploy capacity in advance in order to prepare for future use.

Generally, if not indicated otherwise, the terminology used in connection with the present invention follows the terminology used in the CPRI specification (for reference, see CPRI Specification V6.1 (2014 Jul. 2001) “Common Public Radio Interface (CPRI); Interface Specification”).

According to a preferred embodiment, the radio base station system may comprise an aggregation point that performs a fragmentation of the non-CPRI frames that are to be transmitted via the CPRI link. This fragmentation may be performed in accordance with the amount of spare bandwidth (resulting from the CPRI option the CPRI link underlies and from the amount of CPRI traffic aggregated on the CPRI link). In addition, the aggregation point may be in charge of multiplexing the fragmented non-CPRI frames with the CPRI traffic carried by the CPRI link.

According to a preferred embodiment, the aggregation point may include a number of queues for queuing non-CPRI traffic. For instance, aggregated non-CPRI traffic from different sources may each be queued in a specific queue. Moreover, the aggregation point may include a fragmentation buffer that is fed with CPRI frames from the queues. The fragmentation buffer may be configured to maintain the portions of non-CPRI frames that have not yet been injected into the CPRI link.

According to a preferred embodiment, the radio base station system may comprise a deaggregation point, basically in charge of de-multiplexing, buffering and reassembling the non-CPRI frames at an endpoint of the CPRI link or at any intermediate hop. For instance, the deaggregation point may be located on the CPRI link ahead of the at least one REC that terminates the CPRI link, wherein the deaggregation point is configured to recover and reassemble said non-CPRI frames.

According to a preferred embodiment, the CPRI link may be an aggregated CPRI link that carries CPRI traffic from a (daisy) chain of REs. For instance, multiple CPRI streams may be aggregated into a high data rate CPRI link with some spare capacity where, preferably, the CPRI link is a high speed link of at least 10137.6 Mbps as link rate.

While, generally, any kind of traffic originating from data sources other than CPRI data sources can be encapsulated within the spare capacity of the CPRI link in accordance with the present invention, according to a preferred embodiment the non-CPRI frames may be (variable-size) Ethernet frames, which account for a significant portion of the overall traffic that typically has to be processed by radio base station systems. Consequently, a highly efficient way of exploiting unused resources of CPRI-based C-RAN solutions will be achieved by this embodiment. Since frame sizes of Ethernet frames are usually longer than the spare capacity within a single CPRI basic frame, the above mentioned mechanisms for assembling and disassembling such Ethernet frames can be suitably applied.

According to a preferred embodiment, the aggregated CPRI link may aggregate CPRI traffic from a number of Radio Equipments, RE. In this context it should be noted that, when the aggregation mechanism computes the spare/free capacity based on the current configuration of the channel, this spare/free capacity is a constant for every CPRI basic frame of the CPRI link if the number of CPRI links aggregate it does not change. Therefore, once the amount of free bandwidth is known, the non-CPRI frames can be fragmented according to this capacity. In this context it is further important to note that according to embodiments of the present invention the bandwidth available to the Ethernet transmission is deterministic. This fact is highly beneficial since the operator of the link can know in advance the available capacity of the link and dimension the network accordingly.

According to a preferred embodiment, as already mentioned above, the encapsulation or multiplexing of non-CPRI frames within an (aggregated) CPRI link's spare capacity may be performed by fragmenting the non-CPRI frames according to the spare bandwidth. In order to facilitate de-multiplexing and reassembling, the fragmentation process may be accompanied by an effective fragment indication mechanism. For instance, this mechanism may include the introduction of frame delimiter sequences at the beginning and at the end of the non-CPRI frames.

According to a preferred embodiment, the unused capacity of the control word of a CPRI basic frame may be employed for introducing signaling and/or control information related to the non-CPRI frames that are contained in the respective CPRI basic frame. For instance, the unused capacity of the control word of a CPRI basic frame may be employed for introducing information on the byte or word where the non-CPRI frames contained in the respective CPRI basic frame start. Additionally or alternatively, the unused capacity of the control word of a CPRI basic frame may be employed for introducing a flag that indicates whether a non-CPRI frame carried within the respective CPRI basic frame is fragmented or not. In this context, according to a preferred embodiment the unused capacity of the control word of a CPRI basic frame may be employed for introducing two flags (each flag occupying a single bit of the control word): a first flag that indicates whether the first non-CPRI frame carried within the respective CPRI basic frame is fragmented or not, and a second flag that indicates whether the last non-CPRI frame carried within the respective CPRI basic frame is fragmented or not.

For instance, the aggregation point may fragment the non-CPRI (e.g. Ethernet) frames, append them to the CPRI basic frame and use the empty control bytes to add information about the point where the non-CPRI (e.g. Ethernet) frame starts. In addition, a flag may be set up in the next free control byte to signal if the last non-CPRI (e.g. Ethernet) frame included in the CPRI basic frame is a fragment or not (‘more fragments flag’).

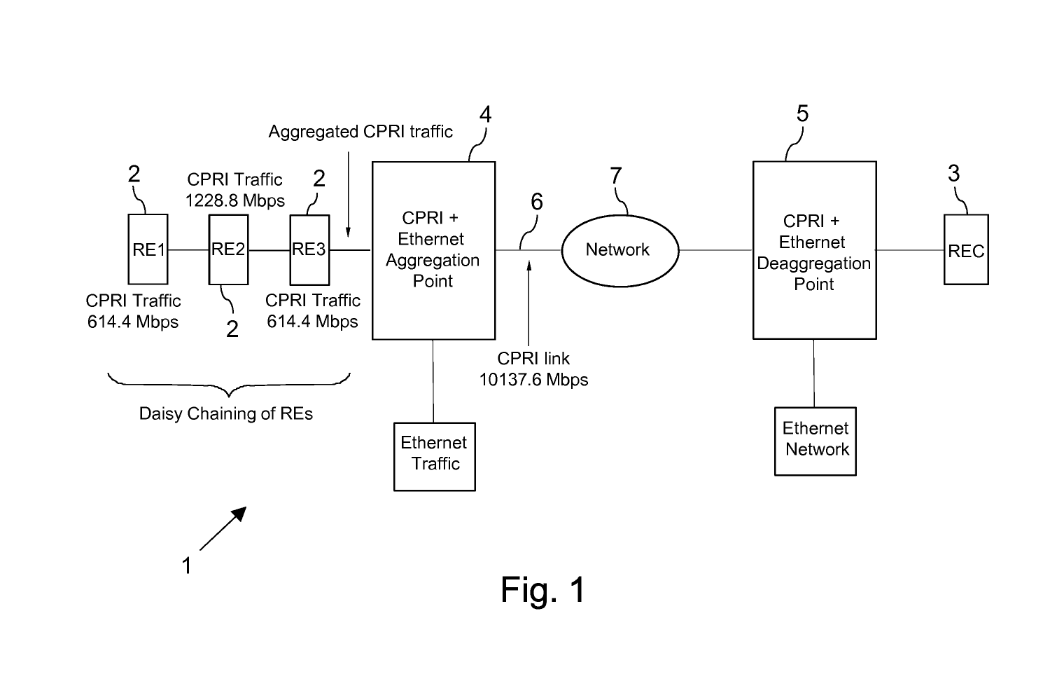

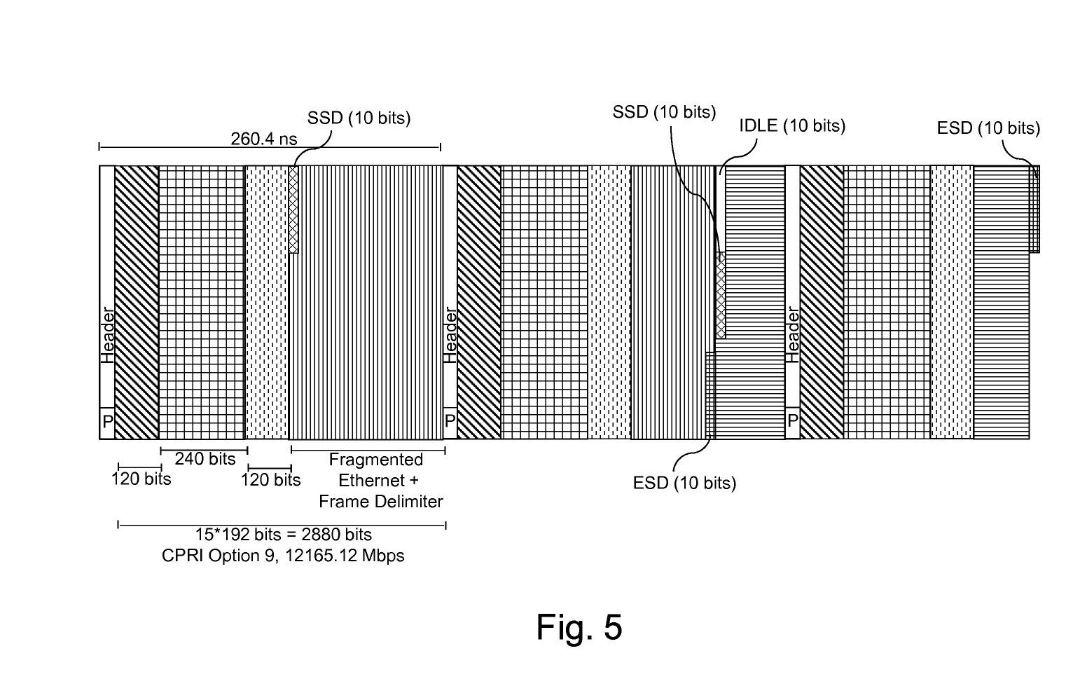

FIG. 1 is a schematic view of a radio base station system 1 in accordance with embodiments of the present invention. Basically, the radio base station system comprises Radio Equipments 2, REs, that serve as an air interface and that provide the analogue and radio frequency functions (such as filtering, modulation, frequency conversion and amplification), and Radio Equipment Control 3, REC, that is concerned with the network interface transport, the radio base station control and management as well as the digital baseband processing. In the illustrated embodiment a number of three REs 2 (RE1, RE2, RE3) are arranged in a chain topology in accordance with the topology specified in FIG. 5A of CPRI Specification V6.1 (2014 Jul. 2001). However, as will be easily appreciated by those skilled in the art the present invention is not limited to this chain topology, but can be applied in connection with other topologies, in particular in connection with the reference configurations described in section 2.3 of CPRI Specification V6.1 (2014 Jul. 2001), which is incorporated herein by way of reference.

In accordance with embodiments of the present invention the radio base station system 1 comprises an aggregation point 4 and a deaggregation point 5 (hereinafter termed CPRI-Ethernet aggregation point 4 and CPRI-Ethernet deaggregation point 5, respectively). FIG. 1 depicts these two building blocks that enable the transmission of CPRI traffic and non-CPRI traffic (in the illustrated embodiment comprised of Ethernet frames) together over a high data rate CPRI link 6 that connects the REs 2 and the REC 3 with each other. In the illustrated scenario, this CPRI link 6 is a 10137.6 Mb/s link (in accordance with CPRI option 8). This link 6 goes through a dedicated network 7 consisting of fiber optics, in general.

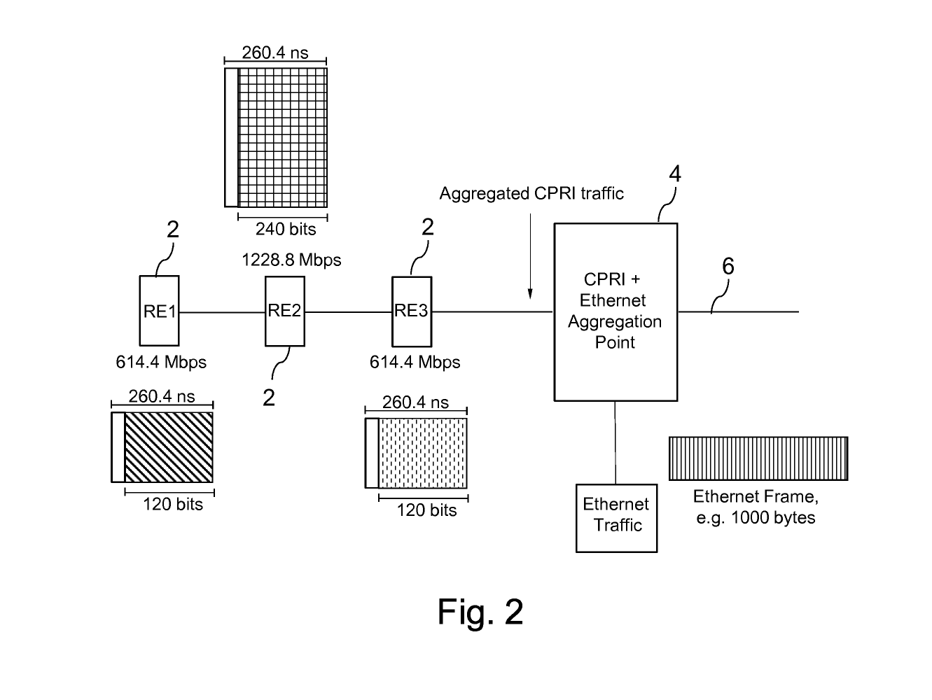

The CPRI-Ethernet aggregation point 4 works in a daisy chain, gathering as input the daisy chain combination of several CPRI links of a number of REs 2 (following standard operation of the CPRI specification). As illustrated in FIG. 2, which depicts the REs 2 and the CPRI-Ethernet aggregation point 4 of FIG. 1 in more detail, the different RE 2 inputs consist of CPRI frames of 260.4167 ns of duration whose size (in bytes) depend on the CPRI data rate option. In this scenario, there are two 614.4 Mb/s (CPRI option 1) sources (RE1 and RE3) and one 1228.8 Mb/s source (RE2). The aggregation of CPRI flows can be easily achieved following the CPRI specification by providing a daisy chain of REs 2 which combine the CPRI input and the traffic generated by the REs 2.

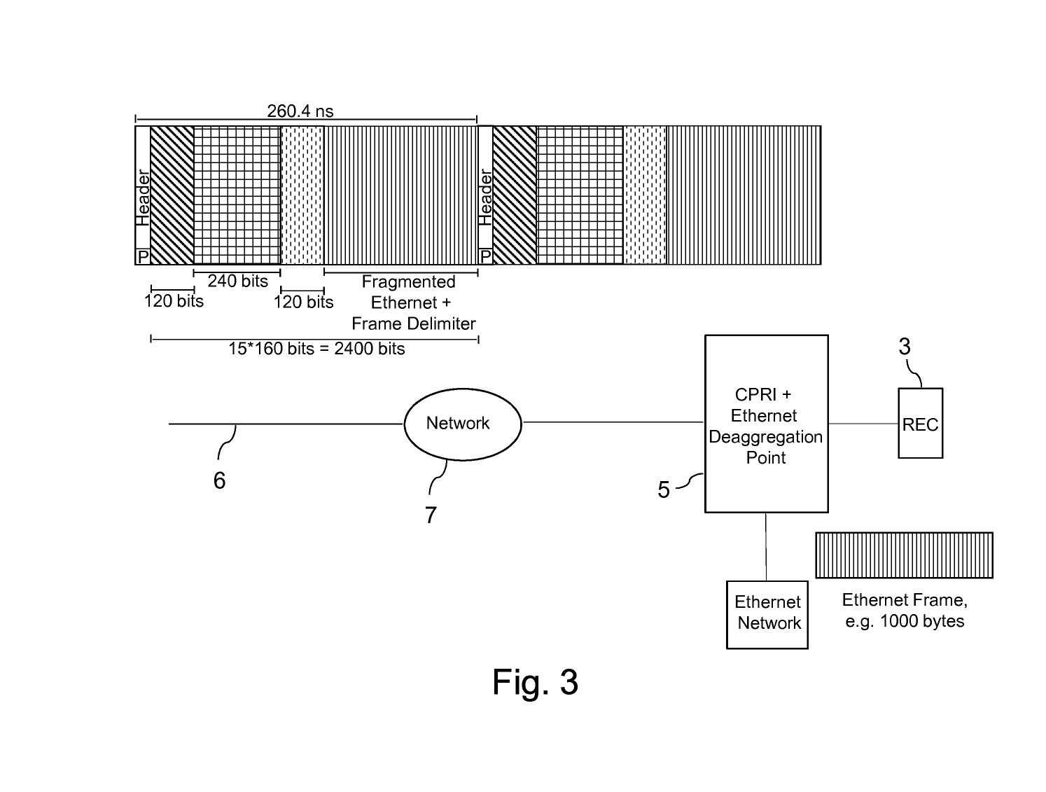

In the represented case, the CPRI-Ethernet aggregation point 4 connects with a CPRI link 6 operating at 10137.6 Mb/s. In such a link, every CPRI basic frame has a duration of 260.4167 ns and carries exactly 16×160=2560 bits, split into 1 word of control and 15 words of data (in other words, 2400 bits of data), as can best be obtained from FIG. 3, which illustrates the CPRI-Ethernet deaggregation point 5 and the REC 3 of FIG. 1 in more detail. From this total of 2400 bits of data, each CPRI option 1 flow takes 120 bits and the CPRI option 2 flow takes 240 bits, that is a total of 480 bits used in the transmission of the I/Q samples, thus leaving 1920 bits unused per Basic Frame (i.e. 75% of the link's capacity, or 7603.2 Mb/s), as shown in FIG. 3. Such spare capacity can be used to transfer other-than-CPRI data. In the case of Ethernet data, frame sizes are usually longer than such 1920 bits (240 bytes), thus requiring a mechanism to assemble and disassemble such Ethernet frames encapsulated on the spare capacity of CPRI basic frames.

Embodiments of the present invention consider the multiplexing of Ethernet frames within the spare capacity of the aggregated CPRI link 6. According to these embodiments the CPRI-Ethernet aggregation mechanism will compute the spare capacity based on current configuration of the channel. Here, it should be noted that this free capacity is constant for every CPRI basic frame of the link 6 if the number of CPRI links aggregated does not change. Once the amount of free bandwidth is known, the Ethernet frames will be fragmented according to this capacity, and a frame delimiter sequence will be introduced at the start and end of the frame.

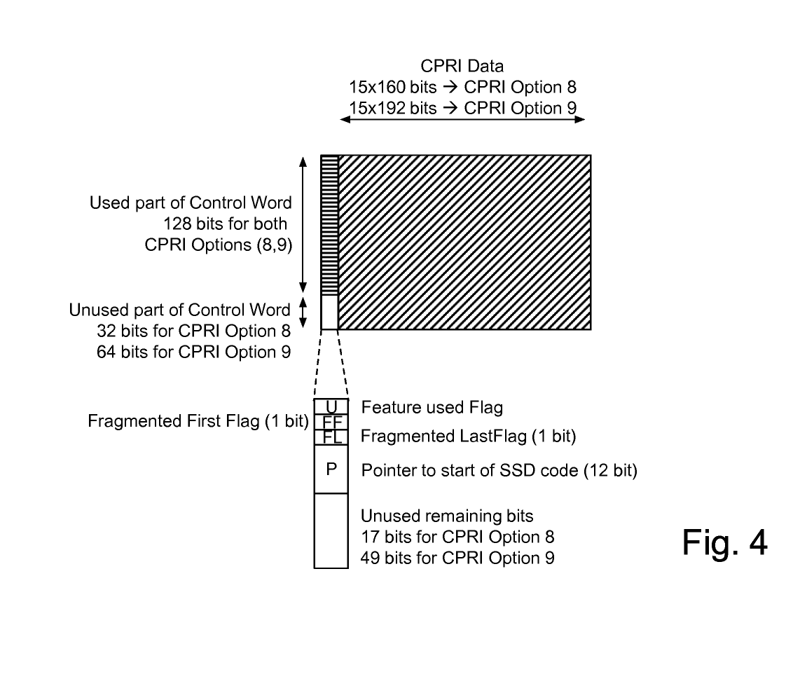

FIG. 4 illustrates the adaptation of the control word of a basic CPRI frame in order to account for the placement of signaling and control information in accordance with an embodiment of the present invention. According to this embodiment the remaining capacity of the control word is employed to include information on the byte or the word where the non-CPRI (e.g., Ethernet) traffic starts and to indicate whether the non-CPRI frames carried by this basic CPRI frame include any fragmented frames or not.

In this context it is important to note that the first word in every Basic Frame is reserved for control, while the other 15 words are used to carry data. This control word has the same size as data words. In the case of CPRI options 8 and 9, the length of each word is 160 and 192 bits, respectively. In FIG. 4, the control word is specifically indicated and enlarged on the left side of the illustrated CPRI basic frame, while the 15 data words are depicted as a whole, represented by the diagonally shaded area.

According to the current CPRI specification only 128 bits are used for actual CPRI control (TCW=128, see the table below). The remaining bits in the control word (i.e. 32 and 64 bits, respectively) can thus be used to define the fragmentation control.

| | | Number of bits used |
|---|---|---|
| CPRI line bit rate | Word length | of the control word |
| 10137.6 (CPRI option 8) | T = 160 | TCW = 128 |
| 12165.12 (CPRI option 9) | T = 192 | |

According to the illustrated embodiment the unused part of the Control Word is employed to include three different flags (i.e. three times 1 bit), denoted ‘U’, ‘FF’ and ‘FL’. The meaning of these flags will be described in more detail below. In addition to these flags, the unused part of the Control Word is employed to include a pointer P having a size of 12 bits in the present embodiment. Consequently, 17 unused bits remain for Option 8 (and 49 bits for Option 9, respectively). In general, the signaling and control mechanism follows the CPRI specification to identify start and end of the Ethernet frames.

The pointer P is configured to indicate the offset which specifies the starting point of the non-CPRI fragment within the CPRI Basic Frame. Therefore, at least log2 (16*T) bits should be reserved for this pointer. Since 2̂12=4096 spans the largest Basic Frame, which accounts for 16×192=3072, 12 bits would be sufficient (as illustrated in the embodiment of FIG. 4). Regarding the placement within the control word, for instance, this pointer P can be located starting on the next bit after the finalization of the control bits used on the control word, i.e. in bit 129 of the control word for both CPRI options 8 and 9. Alternatively, as illustrated in FIG. 4, the pointer P may be located starting on the next bit after the finalization of the above mentioned flags, i.e. in bit 132 of the control word for both CPRI options 8 and 9. However, as will be appreciated by those skilled in the art, implementations different from the ones mentioned above can be realized.

In addition to the pointer P, a total of three bits (flags ‘U’, ‘FF’ and ‘FL’) are introduced to signal the transport of a fragmented frame within the CPRI Basic Frame, as already mentioned above. While flag ‘U’ (bit 129 of the control word in FIG. 4) generally indicates that a CPRI Basic Frame includes a non-CPRI data transport block (i.e. carries at least a part of one non-CPRI frame), flag ‘FF’ (bit 130 in FIG. 4) indicates the transport of a fragmented non-CPRI frame at the beginning of the non-CPRI data transport block and ‘FL’ (bit 131 in FIG. 4) indicates the transport of a fragmented non-CPRI frame at the end of the non-CPRI data transport block. It should be noted that the identification of multiple frames within the non-CPRI data transport block can be done by scanning of the SSD/ESD (Start/End-of-Stream-Delimiter) and IDLE sequences that are used to separate frames (as will be explained below in connection with FIG. 5). In the embodiment of FIG. 4, the meaning of each of the combinations of these flags can be interpreted as follows:
U=‘0’, FF=‘X’, FL=‘X’: Feature not used, no non-CPRI frames are transmitted.
U=‘1’, FF=‘0’, FL=‘0’: N complete frames are transported. P points to an SSD code. The end of the frame is an ESD code.
U=‘1’, FF=‘0’, FL=‘1’: The first frame found in the non-CPRI transport block is complete, P points to an SSD block. The last frame transmitted in the block is fragmented.
U=‘1’, FF=‘1’, FL=‘0’: The first frame found in the non-CPRI transport block is a fragment, P points to frame data. The last transported frame is complete, the last 10 bits of the frame are an ESD code.
U=‘1’, FF=‘1’, FL=‘1’: First and last frames of the non-CPRI transport block are fragments, P points to data and the last bits of the frame are data

With this information, the offset (indicated by pointer P) allows to identify the starting bit of the non-CPRI (e.g. Ethernet) fragment within the CPRI basic frame, while the 10 bit frame delimiter based on ESD, End of Frame, and SSD, Start of Frame (as defined in the CPRI specification (section 4.2.7.7.2) in connection with the definition in IEEE Std 802.3,-2012 IEEE, New York, USA, 28 Dec. 2012, FIG. 49-7) can be used to reassemble the fragments together at the CPRI-Ethernet deaggregation point 5.

At the end-point of the CPRI link 6, or at any intermediate hop, the non-CPRI (e.g. Ethernet) traffic can be de-multiplexed, buffered and reassembled. Extracting the Ethernet frames out of the CPRI basic frame is straight forward and the amount of buffer required to perform the reassembly operation can be deterministically determined.

FIG. 5 shows how different frames are fragmented and injected in the CPRI basic frames. Once the aggregated CPRI lines are included in the higher speed CPRI link 6, the CPRI-Ethernet aggregation point signals the starting of a new frame by introducing an SSD code (in accordance with the current CPRI specification coded in 64B/66B for CPRI options 8 and 9). After the code, the aggregation point 4 will inject a number of bytes belonging to the non-CPRI, i.e. Ethernet, frame. The maximum number of bits that can be carried by the frame depends on the CPRI option used in the link 6 and the number of CPRI links that have been aggregated. In the case depicted in FIG. 5, the CPRI-Ethernet aggregation point 4 will be able to inject 2880—2×120−240−10=2390 bits (or approximately 300 bytes). This process will be repeated until the respective Ethernet frame is completely transmitted. The finalization of the Ethernet frame is signaled to a peer of the communication by introducing an ESD code (coded in 64B/66B for CPRI options 8 and 9). It is noted that, as mandated by the CPRI specification, if a fragment of a second Ethernet frame is sent in the same CPRI basic frame, there must be a separation of 10 bits between the ESD and SSD codes. This separation is encoded as IDLE code.

In the particular example shown in FIG. 5, CPRI option 9 is used to transport three CPRI flows: two CPRI option 1 (three 2.5 MHz AxCs each) and one CPRI option 2 (three 5 MHz AxCs) requires a total use of 2×120+240 bits of data per basic frame (480 bits); while the total amount of data that fits in basic frame is T*(W−1)=192*15=2880 bits. In accordance with the CPRI specification, here the abbreviation ‘AxC’ stands for ‘antenna-carrier’, wherein one antenna-carrier is the amount of digital baseband (IQ) U-plane data necessary for either reception or transmission of only one carrier at one independent antenna element.

In general, the amount of bits per basic frame that can be used to transport Ethernet frames follows:

Nₛₚₐₜₑ=T*(W−1)−30*N_{AxC} bits,

where N_{AxC} is the number of basic 2.5 MHz AxCs transported, W=16 (1 word for control and 15 words for data) and T is the word length (T=160 for CPRI option 8 and T=192 for CPRI option 9). These numbers do not take into account the overhead bits to signal the beginning or end of frames (i.e. 10 bits ESD, SSD and IDLE code). Depending on the Ethernet frame size, none, one or many of such codes may appear within the basic frame.

For example, consider a configuration with 6 antennas covering 3 sectors each, all of them using 2.5 MHz LTE channels, in a daisy chain configuration as in FIG. 1. The spare capacity per basic frame is:
Nₛₚₐᵣₑ=160*15-30*18 bits=1860 bits (232.5 bytes) for CPRI option 8
Nₛₚₐᵣₑ=192*15-30*18 bits=2340 bits (292.5 bytes) for CPRI option 9

Thus, the transmission of an Ethernet frame of 1500 bytes would require 7 basic frames for option 8 (the upper integer of 1500/232.5) or 6 frames (1500/292.5) for option 9. Therefore, the total transmission delay of the Ethernet frame in the first case would be 7*260.4167 ns=1.82 us and in the second case 6*260.4167 ns=1.56 us.

It is worth remarking that the transmission delay of a 1500-byte Ethernet frame over a 10 Gb/s Ethernet link requires only 1.2 us, which is slightly shorter. The extra delay in this case (0.62 us and 0.36 us, respectively) is obviously due to the transmission of the AxCs bits and the control word, which are embedded within the Ethernet frame.

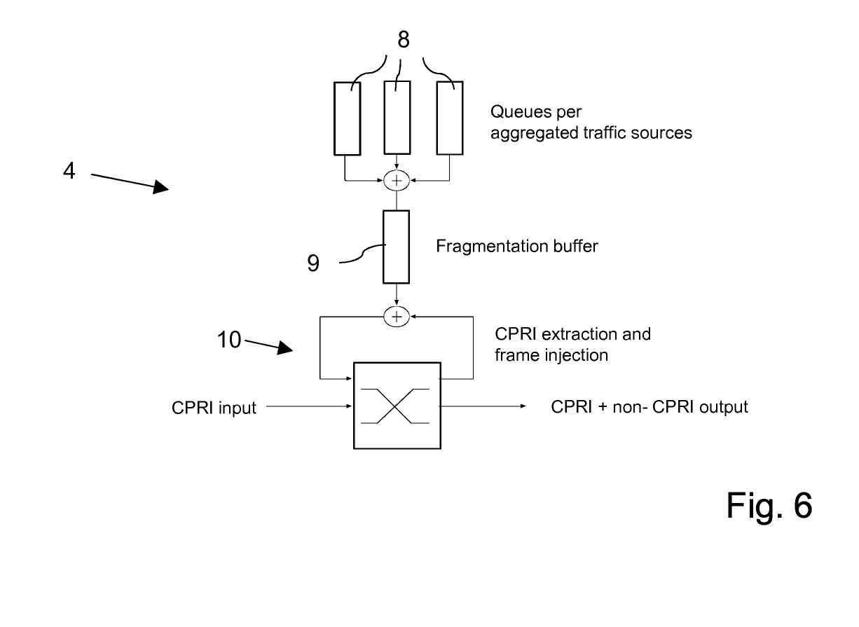

FIG. 6 illustrates the structure of a CPRI-Ethernet aggregation point 4 in accordance with an embodiment of the present invention, configured to inject the non-CPRI traffic in the CPRI aggregation link 6. This is done by extracting the CPRI aggregated link and injecting the new fragmented frame directly in the signal provided. The system comprises several queues 8 to buffer the data originated in different sources (e.g., Small Cells) and a fragmentation buffer 9 in charge of maintaining the portion of a frame not yet transmitted through the CPRI link 6. From the fragmentation buffer 9, the non-CPRI frame fragments are handed over to a CPRI extraction and frame injection engine 10, which is configured to multiplex the non-CPRI frame fragments with the incoming aggregated CPRI traffic. According to an embodiment, the aggregation point 4 can be regarded as a node in the network in daisy chain configuration with the CPRI link 6 that also includes a buffer where Ethernet frames are temporally stored and attached at the particular positions within the CPRI basic frames as well as a capacity computation (or configured manually) entity and a fragmentation engine.

In addition, the queues 8 per aggregated traffic sources in FIG. 6 may also employ classical Weighted-Fair Queuing or Deficit Round Robin disciplines to allow a customized share of the total bandwidth among different Ethernet flows. For example, considering the same configuration as in the previous examples, with three antennas in a daisy chain using a total of 480 bits from the basic frame of a CPRI option 9 link (2880 data bits total): In this case, the bandwidth rate for the transmission of non-CPRI flows is:

(12165.12 Mbit/s)*(2880−480)/(2880)=10137.6 Mbit/s

The 802.1Q VLAN (Virtual Local Area Network) tag provides 3 bits of Priority Control Point which allows specifying up to 8 classes of traffic on attempts to provide service differentiation at the switches. This functionality may be used to enable a customized partition share of the bandwidth among the 8 traffic classes, just by assigning different weights to such eight Virtual Output Queues.

To summarize, embodiments of the present invention relate to the following mechanisms:
A mechanism by which a networking node is capable of aggregating multiple CPRI streams into a high data rate CPRI link with some spare capacity.
A fragmentation mechanism capable of splitting Ethernet frames into multiple fragments that fit according to the space left free in the CPRI basic frame.
New control information introduced in the CPRI basic frame control word used to signal the byte within the CPRI basic frame body where the Ethernet frame starts and to indicate if more fragments of the same Ethernet frame will be transmitted in the next CPRI basic frame.
A buffering and reassembly mechanism at the end of the CPRI+Ethernet link capable of collecting the Ethernet fragments and reassembling them into the original frame.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radio base station system, comprising:
at least one Radio Equipment Control (REC) that comprises radio functions of a digital baseband domain,
at least one Radio Equipment (RE) serves as an air interface and comprises analogue radio frequency functions, and
a Common Public Radio Interface (CPRI) link connecting the at least one REC and the at least one RE, wherein CPRI traffic carried by the CPRI link leaves an amount of spare capacity, and wherein the CPRI link carries non-CPRI traffic encapsulated within the spare capacity.

2. The system according to claim 1, further comprising an aggregation point configured to perform a fragmentation of non-CPRI frames according to spare bandwidth and to perform multiplexing of the non-CPRI frames with the CPRI traffic carried by said CPRI link.

3. The system according to claim 2, wherein the aggregation point includes a number of queues for queuing the non-CPRI traffic per aggregated non-CPRI traffic sources.

4. The system according to claim 3, wherein the aggregation point includes a fragmentation buffer connected to the queues, wherein the fragmentation buffer is configured to maintain portions of the non-CPRI frames not yet infected into the CPRI link.

5. The system according to claim 1, further comprising a deaggregation point located on the CPRI link ahead of the at least one REC that terminates the CPRI link, wherein the deaggregation point is configured to recover and reassemble the non-CPRI frames.

6. The system according to claim 1, wherein the CPRI link is an aggregated CPRI link that carries the CPRI traffic from a chain of REs.

7. The system according to claim 1, wherein the CPRI link is a high speed link having a link rate of at least 10137.6 Mbps.

8. A method for Column Public Radio Interface (CPRI) basic frame assembly, the method comprising:
providing an aggregated CPRI link that carries CPRI traffic from one or more CPRI links,
determining an amount of spare capacity of the aggregated CPRI link, and
encapsulating non-CPRI frames within said-the spare capacity.

9. The method according to claim 8, wherein the non-CPRI frames include Ethernet frames.

10. The method according to claim 8, wherein the aggregated CPRI link aggregates the CPRI traffic from a number of Radio Equipment (RE).

11. The according to claim 8, wherein the encapsulation of the non-CPRI frames within the spare capacity of the aggregated CPRI link is performed by fragmenting the non-CPRI frames according to said-spare bandwidth and by introducing a frame delimiter sequence at the beginning and at the end of the non-CPRI frames.

12. The method according to claim 8, wherein unused capacity of a control word of a CPRI basic frame is employed for introducing signaling and/or control information related to the non-CPRI frames.

13. The method according to claim 8, wherein unused capacity of a control word of a CPRI basic frame is employed for introducing information on a byte or word where said non-CPRI frames start.

14. The method according to claim 8, wherein unused capacity of a control word of a CPRI basic frame is employed for introducing a flag that indicates whether one of the non-CPRI frames carried within the CPRI basic frame is fragmented or not.

15. The method according to claim 8, wherein unused capacity of a control word of a CPRI basic frame is employed for introducing a first flag that indicates whether a first non-CPRI frame carried within a CPRI basic frame is fragmented or not and a second flag that indicates whether a last non-CPRI frame carried within the CPRI basic frame is fragmented or not.
